(19) United States
(12) Patent Application Publication
(10) Pub. No.: US 2006/0221298 A1
(43) Pub. Date: Oct. 5, 2006

(54) Diving mask and viewfield lens therefor

(75) Inventors: Kazumi Matsumoto, Hadano (JP); Tetsuo Yoshizawa, Ebina (JP)

Correspondence Address: BIRCH STEWART KOLASCH & BIRCH, PO BOX 747, FALLS CHURCH, VA, 22040-0747, US

(73) Assignees: HIT DESIGN LTD.; Apollo Sports Co., Ltd.

(21) Appl. No.: 11/385,781

(22) Filed: Mar. 22, 2006

(30) Foreign Application Priority Data
Mar. 29, 2005 (JP) 2005-093472

(51) Int. Cl. G02C 1/00

(52) U.S. Cl. 351/43

(57) ABSTRACT

The diving mask is capable of suitably restraining abnormal image vision and which can be precisely produced at low cost. The diving mask of the present invention comprises a viewfield lens, which is constituted by a flat front section and side sections extended from the front section. The side sections are formed like toric faces, and the side sections respectively have Fresnel lens parts capable of correcting negative refracting power under water.

### BACKGROUND OF THE INVENTION

The present invention relates to a diving mask and a viewfield lens therefor, which is capable of correcting refracting power of side sections of the lens so as to suitably broaden viewfield under water.

A typical diving mask is shown in FIG. 1. The diving mask has a viewfield lens 100. The viewfield lens 100 includes a flat front section 101 and side sections 102, which are extended from the front section 101. Shapes of the side sections 102 are curved faces, each of which corresponds to a part of a side wall of a cylinder.

If the field view lens 100 has fixed thickness (see FIG. 2(A)), an image seen through the side section 102 is distorted (see FIG. 2(B)). FIG. 2(A) is a sectional view of the viewfield lens 100, and FIG. 2(B) shows visions of the image corresponding to visual lines a-d. The distortion is occurred by difference of refraction indexes between air and water, which makes the side sections 102 of the viewfield lens 100 work as concave lenses in a lateral direction. Namely, the side sections 102 work like fish-eye lenses in the lateral direction, so that the image is minified.

To solve the abnormal vision, U.S. Pat. No. 5,420,649 discloses an improved diving mask shown in FIGS. 3(A) and 3(B). FIG. 3(A) is a sectional view of a viewfield lens 100a, and FIG. 3(B) shows visions of an image corresponding to visual lines a-d. In the U.S. Pat. No. 5,420,649, prisms 105 are provided to side sections 102a. With this structure, refracting power of the side sections 102a of the viewfield lens 100 is corrected, so that vision of the image can be improved. Note that, a symbol 101a stands for a front section of the viewfield lens 100a. However, as shown in FIG. 3(B), distortion of the image cannot be fully solved. And, boundaries between the side sections 102a and the prisms 105 are discontinued, so dead angles are formed and ghost images appear. Further, the prisms 105 are big, so the diving mask must be large in size.

To solve the problems of the diving mask disclosed in the U.S. Pat. No. 5,420,649, the inventors of the present invention proposed a diving mask shown in FIG. 4. FIG. 4 is a sectional view of a viewfield lens 100b. Fresnel lens parts 103b are respectively formed in side sections 102b of the viewfield lens 100b. Note that, a symbol 110 stands for an outer lens part, and a symbol 120 stands for an inner lens part. Further, symbols e stand for eye balls, and a symbol 101b stands for a front section.

The improved diving mask is capable of restraining abnormal refracting power, image distortion and abnormal stereophonic vision, and capable of realizing a broad viewfield without forming dead angles and producing ghost images. The diving mask can be small in size.

However, precise and high-cost production technology is required so as to manufacture the Fresnel lens parts 103b in circular curved faces of the side sections 102b. For example, in case of a die for mass production, a plurality of parallel grooves in the circular curved faces, but it is difficult to manufacture the die with high accuracy. Therefore, the diving mask cannot be mass-produced at low cost.

### SUMMARY OF THE INVENTION

The present invention was conceived to solve the above described problems.

An object of the present invention is to provide a diving mask and a viewfield lens therefor, which are capable of suitably restraining abnormal image vision and which can be precisely produced at low cost.

To achieve the object, the present invention has following structures.

Namely, the diving mask of the present invention comprises a viewfield lens, which is constituted by a flat front section and side sections extended from the front section,

wherein the side sections are formed like toric faces, and

the side sections respectively have Fresnel lens parts capable of correcting negative refracting power under water.

In the diving mask, the viewfield lens may be formed by at least two layers of transparent materials, and

the Fresnel lens parts may be provided in at least one of facing surfaces of the layers.

In the diving mask, the viewfield lens may include an outer layer and an inner layer, and

the Fresnel lens parts may be provided in an inner face of the outer layer.

In the diving mask, the viewfield lens may be divided into a right lens part and a left lens part, which have the same shapes.

In the diving mask, the innermost face of the viewfield lens may be formed as a curved surface so as to correct power of vision.

In the diving mask, the toric faces may be extended from average pupillary positions or outer sides thereof.

In the diving mask, antifogging treatment may be applied to the innermost face of the viewfield lens.

The viewfield lens for a diving mask comprises:

a front section; and

side sections extended from the front section,

wherein the side sections are formed like toric faces, and

the side sections has Fresnel lens parts capable of correcting negative refracting power under water.

By employing the diving mask and the viewfield lens, abnormal image vision can be restrained, so that a broad viewfield can be gained. Further, the diving mask and the viewfield lens can be precisely produced at low cost.

### BRIEF DESCRIPTION OF THE DRAWINGS

Embodiments of the present invention will now be described by way of examples and with reference to the accompanying drawings, in which:

FIG. 1 is a perspective view of a typical diving mask;

FIG. 2(A) is a sectional view of a viewfield lens of the diving mask;

FIG. 2(B) is an explanation view of image vision of the viewfield lens shown in FIG. 2(A);

FIG. 3(A) is a sectional view of a viewfield lens of a conventional diving mask using prisms;

FIG. 3(B) is an explanation view of image vision of the viewfield lens shown in FIG. 3(A);

FIG. 4 is a sectional view of a viewfield lens of another improved diving mask including Fresnel lens parts;

FIG. 5 is a perspective view of an embodiment of the diving mask of the present invention;

FIG. 6(A) is a sectional view of a viewfield lens of the diving mask shown in FIG. 5;

FIG. 6(B) is an explanation view of image vision of the viewfield lens shown in FIG. 6(A);

FIG. 7 is a perspective view of a die for producing the viewfield lens of the present invention; and

FIG. 8 is a sectional view of a prescription viewfield lens of the present invention.

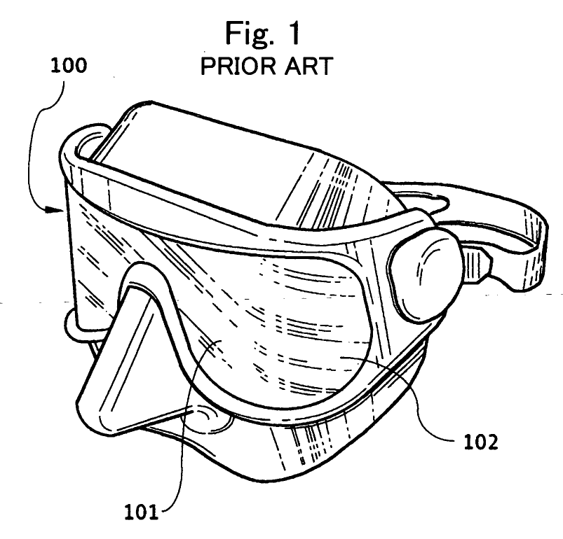

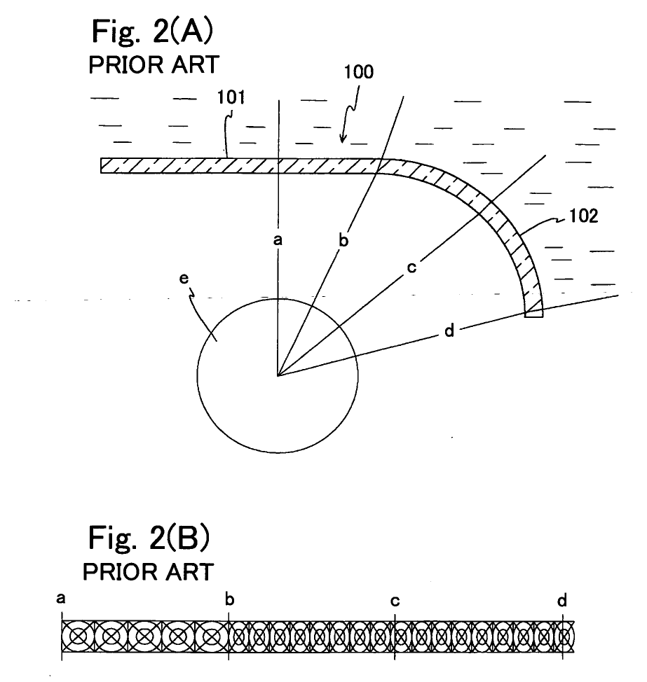

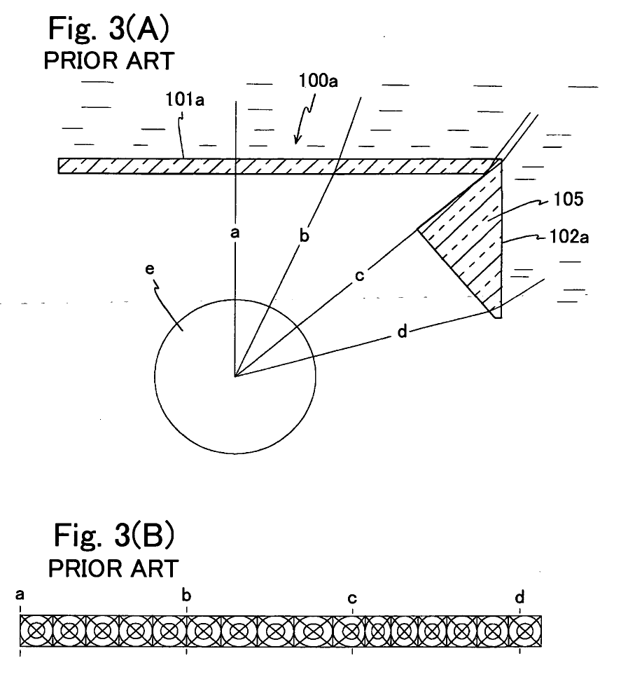

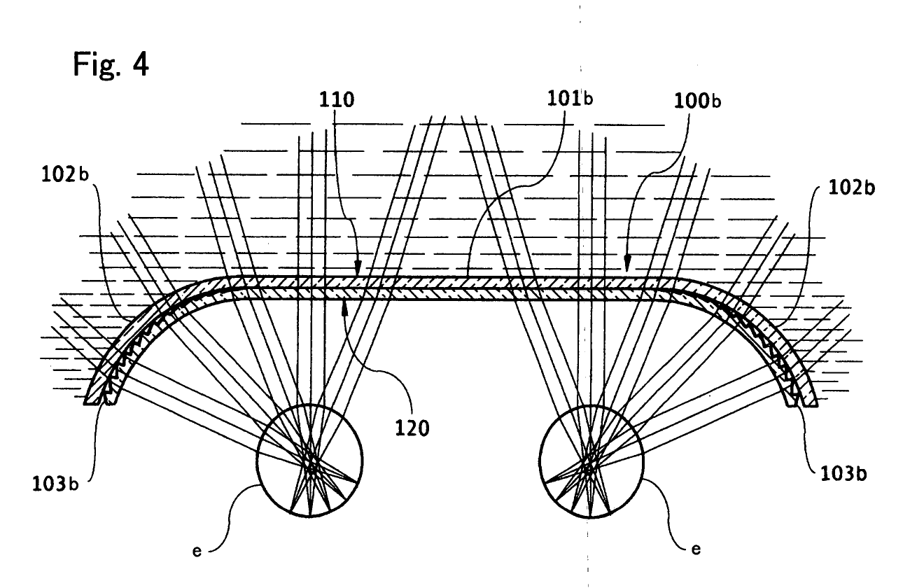

### DETAILED DESCRIPTION OF THE EMBODIMENTS

Preferred embodiments of the present invention will now be described in detail with reference to the accompanying drawings.

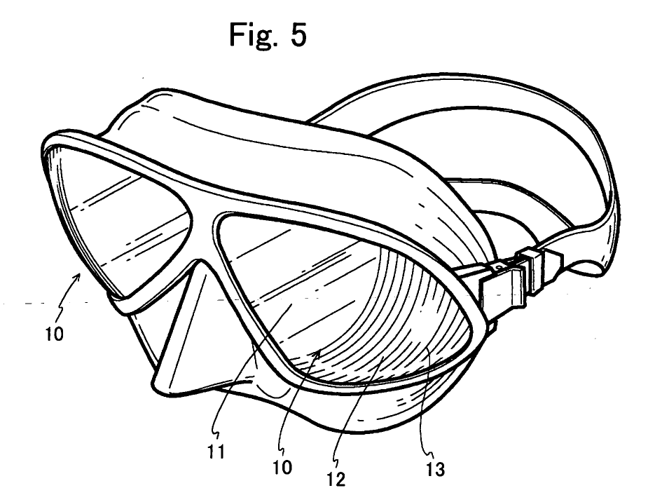

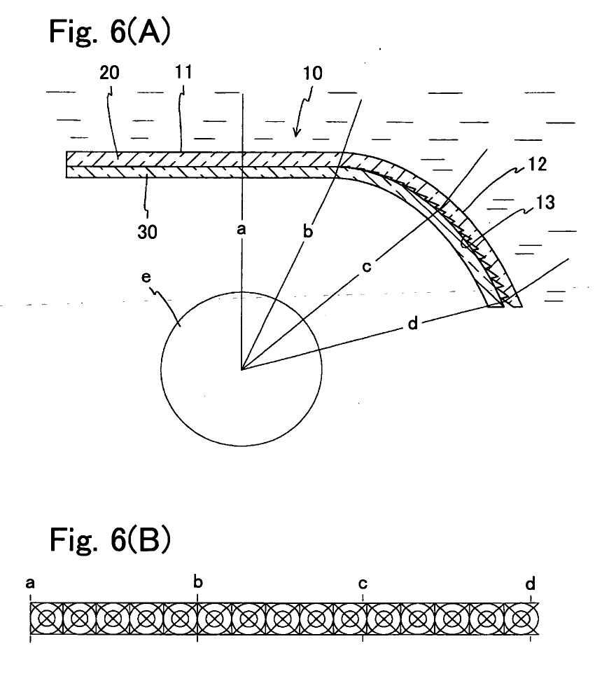

FIG. 5 is a perspective view showing an external shape of an embodiment of the diving mask of the present invention. FIG. 6(A) is a sectional view of a viewfield lens 10 of the diving mask, and FIG. 6(B) is an explanation view showing visions of an image corresponding to visual lines a-d.

The viewfield lens 10 has a flat front section 11 and side sections 12 extended from the front section 11. The side sections 12 are formed like toric faces. The side sections 12 respectively have Fresnel lens parts 13, which is capable of correcting negative refracting power under water. The side sections 12 are curved along a face of a user. Note that, the “toric face” means a curved face along a circle line, whose center is a center of a curvature radius.

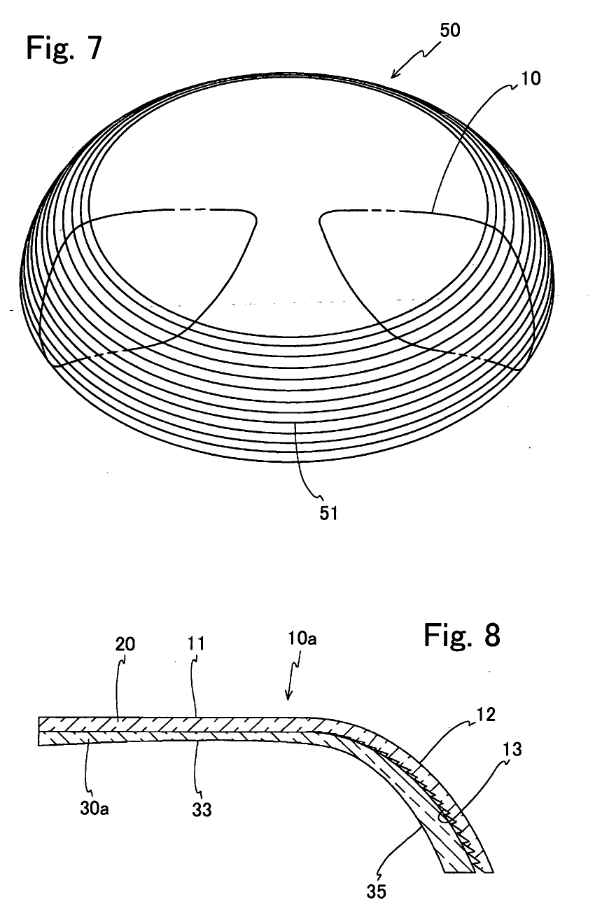

In the present specification, the toric faces are not limited to accurate toric faces, curved faces similar to the toric face may be included. Therefore, faces of the side sections 12 may be curved faces formed on a rotor (see FIG. 7). Namely, curved faces, which can be formed in a resin molding die by lathe-machining, may be employed as the toric faces.

Since the front section 11 is flat, a suitable front viewfield can be seen, with high optical resolution, with both eyes in the air and under water.

The side sections 12 have the Fresnel lens parts 13, which have positive refracting power. Therefore, negative refracting power caused by the curved side sections 12 can be balanced out under water, so that abnormal refraction and image distortion can be restrained. Further, boundaries between the front section 11 and the side sections 12 are optically smoothly continued, so that the suitable viewfield can be realized without forming dead angles and ghost images.

In the present embodiment, the viewfield lens is formed by two transparent layers, i.e., an outer layer 20 and an inner layer 30. The layers 20 and 30 are formed into plate-shapes, each of which has a curved face (the side section 12) formed like the toric face. The two layer 20 and 30 are mutually fitted except groove sections, which act as Fresnel lens elements. The Fresnel lens parts 13 are provided in an inner face of the outer layer 20.

Note that, the viewfield lens of the present invention is not limited to the above described lens 10. The viewfield lens may be constituted by three layers or more. The Fresnel lens parts 13 may be provided in at least one of facing surfaces of the layers. The Fresnel lens parts 13 may be provided in a plurality of surfaces.

In the present embodiment, the viewfield lens 10 is divided into a right lens part and a left lens part, which have the same shapes and the same sizes.

The viewfield lens 10 can be precisely produced, by a resin molding die, at low cost. The reason will be explained.

Firstly, the side sections 12 are formed like the toric faces, so the resin molding die may be formed into a circular shape as shown in FIG. 7. FIG. 7 is a perspective view of the resin molding die 50, which is capable of forming the Fresnel lens parts 13 in the side sections 12 formed like the toric faces. The resin molding die 50 can be precisely manufactured by lathe-machining (cutting work) at low cost. Note that, a part of the rotor 50 shown in FIG. 7 may be used as a die for producing the viewfield lens 10.

The Fresnel lens parts 13 are provided in the inner face of the outer layer 20, so a plurality of ring grooves 51, which is formed for forming the Fresnel lens elements, are grooved in a projected face of the die 50 (see FIG. 7). Forming the grooves 51 in the convex face (the toric face) is easier than forming them in a concave face.

The side sections 12 are formed like the toric faces, so they are symmetrically formed. The right lens part and the left lens part of the viewfield lens 10 may have the same shapes and the same sizes. Therefore, the right lens part and the left lens part of the viewfield lens 10 can be produced in one die 50.

The high quality diving mask and the high quality lens for the diving mask of the present invention can be mass-produced at low cost.

As shown in FIG. 8, the innermost face of a viewfield lens 10a may be formed as a curved surface so as to correct power of vision. The innermost face of the viewfield lens 10a is an inner face of an inner layer 30a. In the embodiment shown in FIG. 8, a front viewfield is corrected by a spherical lens 33; side viewfields are corrected by prescription toric lenses 35. Preferably, an optical axis of a vision correction lens in the front section 11 of the viewfield lens 10a, which is a normal line with respect to a lens surface of the thinnest part for short sight or a normal line with respect to a lens surface of the thickest part for far sight, is coincided with a visual axis while using the diving mask. A resin molding die for producing the prescription lens can be manufactured by lathe-machining as well as the die for producing the outer layer lens 20. Therefore, high quality prescription lens can be mass-produced at low cost.

The toric faces may be extended outward from average pupillary positions or outer sides of the pupillary positions. Further, a part of the viewfield lens 10, which corresponds to a fixation visual field, may be used as the flat front section 11; other parts located on the outer sides of said part may be used as the toric side sections 12. With this structure, a suitable front viewfield can be gained on land. Note that, the “fixation visual field” is a viewfield, in which we can see objects with high optical resolution. On the other hand, a static visual field is extended outward from the fixation visual field.

Further, antifogging treatment may be applied to the innermost face of the viewfield lens 10.

Successively, details of the diving mask of the present embodiment will be explained.

The front section 11 and the side sections 12 are integrated without using a frame. In the viewfield lens 10, the outer layer 20 and the inner layer 30 are air-tightly layered. The layers 20 and 30 are air-tightly layered by applying an adhesive to outer edges of the layers 20 and 30, welding the outer edges thereof, providing a rubber gasket therebetween, etc.

Uneven sections of band-shaped prisms of the Fresnel lens parts 13 are formed in the inner face of the outer layer 20, and spaces between the layers 20 and 30 are air-tightly closed by said manner. With this structure, the uneven sections of the band-shaped prisms can be always dried. Even if pitch of the band-shaped prisms is 0.5 mm or less, no water invades into the uneven sections by capillary phenomenon. Therefore, effects of the Fresnel lens elements can be maintained. By employing fine pitch Fresnel lenses, high resolution viewfield can be realized.

Useless step parts, which are not optically used, are formed in boundaries between the adjacent band-shaped prisms. In the present embodiment, the useless step parts can be removed from the viewfield by adjusting inclination angles thereof. Therefore, ghost images and flare caused by the useless step parts can be restrained, so that a high contrast viewfield can be realized.

Rigid transparent materials for producing the viewfield lens for the diving mask are, for example, glass, plastics of carbonate, acrylic, polyethylene, urethane, epoxy, etc.

The Fresnel lens elements of the veiwfield lens may be formed by press molding, injection molding, molding with UV cure resin, vacuum molding, compression molding, etc.

In the viewfield lens for the diving mask of the present invention, an outer face of the front section 11 need not be a perfect flat face. The outer face of the front section 11 may be a curved face having very small curvature.

The Fresnel lens elements may be provided to not only the side sections of the viewfield lens but also an upper section and a lower section thereof.

The diving mask can be suitably used for scuba diving and skin diving. Further, it can be used as swimming goggle. Further, the view field lenses of the present invention can be commercially dealt as parts of the diving mask.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A diving mask comprising a viewfield lens, which is constituted by a flat front section and side sections extended from the front section,
wherein the side sections are formed like toric faces, and
the side sections respectively have Fresnel lens parts capable of correcting negative refracting power under water.

2. The diving mask according to claim 1,
wherein said viewfield lens is formed by at least two layers of transparent materials, and
the Fresnel lens parts are provided in at least one of facing surfaces of the layers.

3. The diving mask according to claim 1,
wherein said viewfield lens includes an outer layer and an inner layer, and
the Fresnel lens parts are provided in an inner face of the outer layer.

4. The diving mask according to claim 1,
wherein said viewfield lens is divided into a right lens part and a left lens part, which have the same shapes.

5. The diving mask according to claim 1,
wherein the innermost face of said viewfield lens is formed as a curved surface so as to correct power of vision.

6. The diving mask according to claim 1,
wherein the toric faces are extended from average pupillary positions or outer sides thereof.

7. The diving mask according to claim 1,
wherein antifogging treatment is applied to the innermost face of said viewfield lens.

8. A viewfield lens for a diving mask,
comprising:
a front section; and
side sections extended from the front section,
wherein the side sections are formed like toric faces, and
the side sections has Fresnel lens parts capable of correcting negative refracting power under water.
